(19) United States
(12) Patent Application Publication
(10) Pub. No.: US 2013/0190949 A1
(43) Pub. Date: Jul. 25, 2013

(54) VEHICLE ENERGY CONTROL SYSTEM

(71) Applicant: AIRBUS OPERATIONS (SAS), Toulouse (FR)

(72) Inventors: Florian CONSTANS, Pibrac (FR); Thierry BOURRET, Toulouse (FR); Fabien PERRIN, Toulouse (FR)

(73) Assignee: AIRBUS OPERATIONS (SAS), Toulouse (FR)

(21) Appl. No.: 13/719,693

(22) Filed: Dec. 19, 2012

(30) Foreign Application Priority Data
Dec. 19, 2011 (FR) 1161956

(51) Int. Cl. B64D 31/02; B64D 31/04; B64C 19/00

(52) U.S. Cl. CPC B64D 31/02; B64C 19/00; B64D 31/04
USPC 701/3; 701/99

(57) ABSTRACT

A system for controlling energy of a vehicle, for example an aircraft, comprising a control interface able to be in at least one first and one second state, the first state being an instruction state in which the interface generates at least a first instruction for speed of variation of a current energy of the vehicle and the second state being a resting state in which it gives no instruction, the interface furthermore being configured to return into the second state after having been brought into the first state.

The present invention concerns a system for controlling the energy of vehicle for example such as an aircraft.

The energy of a vehicle may be understood as the mechanical energy of the vehicle, that is to say the sum of its kinetic energy and its potential energy. Typically, this energy is controlled via the thrust of the propulsion means of the vehicle for example such as its propulsion engines.

The present description takes the example of aeronautics.

On certain aircraft, the control of the energy is made by means of a throttle handle, for example a lever, which controls the level of thrust of the engines according to its position.

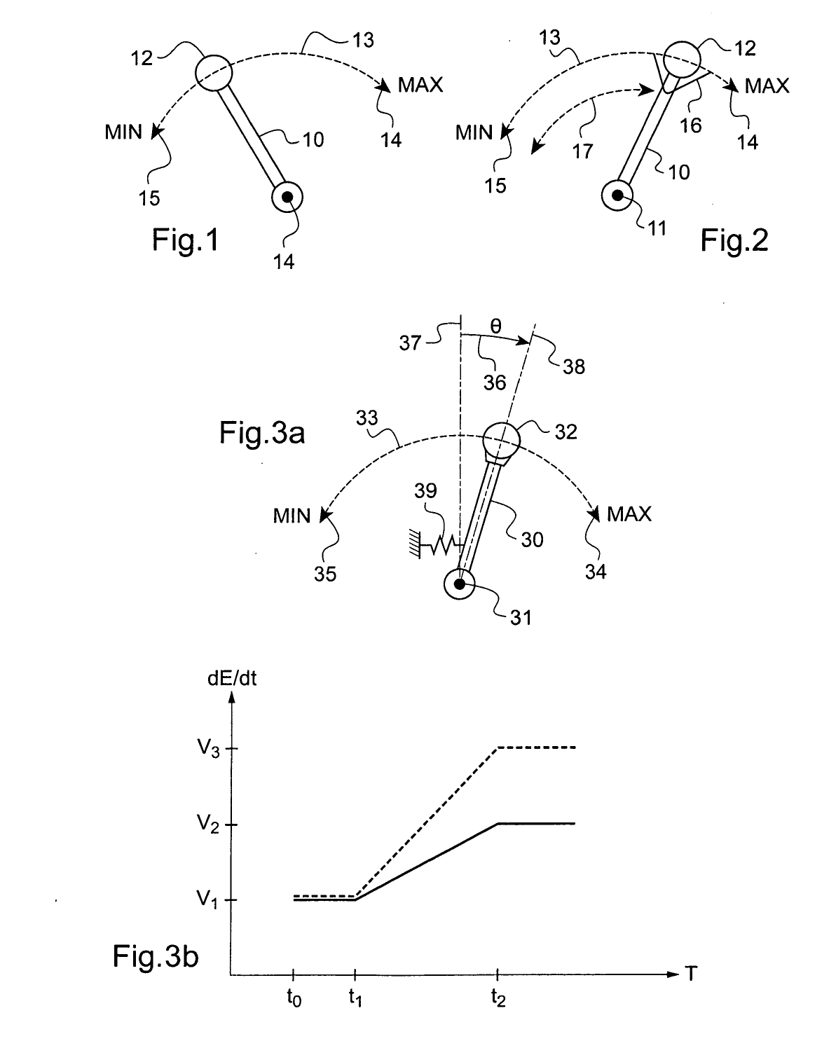

FIG. 1 represents such a lever 10 which may pivot around a rotational axis 11 orthogonal to the plane of the Figure and of which the free end 12 is able to follow a travel path 13. In the position represented in FIG. 1, the lever controls a thrust of the propulsion engines situated between the maximum available thrust, commanded by position 14 (MAX), and the minimum thrust commanded by position 15 (MIN).

When the aircraft is equipped with a system for automatic adjustment of the thrust of the propulsion engines to maintain the velocity of the aircraft, the lever may be equipped with a servomotor at the location of the rotational axis 11 (not shown). This servomotor enables the system to match the position of the lever with the adjustments to the thrust by bringing the lever practically instantaneously into the position corresponding to the current thrust of the propulsion engines determined by the automatic adjustment system.

However, the presence of such a servomotor renders the mechanism of the lever complex, which makes it liable to malfunctions such as failures, jamming in a position, inadvertent movements, etc. The implementation of such a servomotor thus involves clutch mechanisms, override mechanisms and redundancies to ensure the objectives of availability and safety are met. To be precise, the loss of manual control over the thrust of the propulsion engines may have catastrophic consequences and the automatic thrust adjustment function must be highly available.

Alternatively, to avoid the use of servomotors, the lever may be equipped with an intermediate notch 16 as represented in FIG. 2.

FIG. 2 includes all the parts of FIG. 1 with the same reference signs. In aircraft equipped with a lever according to FIG. 2, when the automatic thrust adjustment system of the propulsion engines is active, the level is held by the notch in a fixed position corresponding to the maximum thrust that the propulsion engines can deliver when the system is activated. The lever thus remains fixed, but the propulsion engines may deliver a thrust corresponding to the positions of the lever on the travel path 17 which starts from the position of minimum thrust 15 and goes to the position in which the lever is held in the notch 16.

The mechanical structure of the lever according to FIG. 2, is not made complex by the presence of motorization at the location of the axis 11. However, when transitions are made between a manual control of the thrust and an automatic control of the thrust, the crew may be led to adjust the position of the lever to avoid thrust transients that can result in shaking in the aircraft.

To that end, the crew is typically aided by indications or messages that display on the control panel or by audio messages. These indications or these messages indicate for example the position at which the lever should be located to match the current thrust. The messages may also indicate the procedure to follow to reposition the lever when there occurs a failure such as an inadvertent disengagement of the lever out of the fixing notch. The messages may also indicate an inappropriate position of the handle relative to the state of engagement of the automatic thrust adjustment system, for example if the automatic adjustment has been set off by the control system of the aircraft and not by the pilot. It may also be indicated to the crew when the automatic thrust adjustment system applies a greater thrust than the position of the lever to protect the aircraft against a situation of excessively high energy loss (for example such as the approach of take-off of the aircraft).

In the energy control systems for vehicles, for example of aircraft, no compromise exists between the simplicity of manual control and ease of use.

There is thus a need to improve vehicle energy control systems.

The present invention lies within this context.

To that end, according to a first aspect of the invention, there is provided a vehicle energy control system, for example an aircraft, comprising:
a control interface for generating at least one first instruction for variation of a current energy of the vehicle, and
a regulating unit for receiving said at least one first instruction and for controlling at least one device of the vehicle to bring the vehicle to an energy in accordance with said at least one first instruction.

The control interface may be in at least one first and one second state, the first state being an instruction state in which the interface generates at least one first instruction and the second state being a resting state in which it does not give any instruction. The interface is configured to return to the second state after having been brought into the first state.

For example, the interface returns to the second state after having been released by a user.

The first instruction may be an instruction for speed of variation of a current energy of the vehicle.

The energy of the vehicle corresponds for example to its kinetic energy, its potential energy or the sum of these two energies. The kinetic energy of the vehicle varies according to its velocity, and the potential energy of the vehicle varies according to its altitude. The variation of the energy of the vehicle may be controlled via its propulsive balance, corresponding for example to the difference between the thrust applied to the vehicle by its engines and the aerodynamic drag of the vehicle. The thrust and the drag are not the only forces that may act on the vehicle, other forces may act.

For example, to control the variation in the energy of the vehicle, in particular the thrust of the engines and the aerodynamic parts of the aircraft are controlled.

The system according to the invention makes it possible to overcome the drawbacks of the systems of the prior art since there is no need to return the interface into a particular state to pass from an automatic mode to a manual mode (or the contrary).

To be precise, according to the present invention, the interface always returns to its resting state. Furthermore, the interface does not give any instruction for a particular value of the energy of the aircraft, but an instruction for variation. The interface enables adjustments “by pulse” (or “by touch”), which avoids the problem of repositioning the lever mentioned for the prior art.

The present invention simplifies the piloting of the vehicles, since no action of adjustment of the states of the interface is necessary when passing from an automatic management of the energy to a manual management.

Furthermore, the present invention enables the weight of the control system to be reduced, since it does not require any apparatus for the correction of the state of the interface as mentioned in the prior art (neither servomotor, nor device for correcting the position of the lever or other apparatus).

For example, the first instruction corresponds to a variation in thrust of at least one engine of the vehicle.

Thus, the total energy of the vehicle, in particular its kinetic energy, is easily controlled. The engine may be understood as being a propulsion engine.

For example again, the first instruction corresponds to a command for an aerodynamic device of the vehicle.

The interface may furthermore be configured to generate a second control instruction for a thrust value of at least one engine of the vehicle.

Thus, the advantages given by the present invention are combined with the possibility of directly controlling the thrust for cases of emergency.

The second instruction may for example control at least one aerodynamic device of the vehicle.

Thus, it is possible to act on the energy of the vehicle for example by adjusting the devices for slowing down (air brakes, reversers) or stopping (brakes).

In an embodiment, the interface comprises a lever configured to move angularly around a rotational axis and in which embodiment said at least one first instruction is a function of an angle formed between a current position of the lever and a resting position.

Thus, the interface remains intuitive for pilots who are used to levers to control the energy of the vehicle.

For example, the second instruction is generated in an angular position of the lever requiring a force for positioning on a normal travel path of the lever.

Thus, the pilot feels a difference in the manipulation of the interface between a command for varying the energy and a direct thrust command.

For example, this angular position is situated at the end of travel of the lever.

Thus, the interface has a simple mechanical structure which is little subject to malfunctions.

In some embodiments, the interface comprises at least one actuator for setting off at least one of the first and second instructions.

For example, the actuator is a keyboard button. This keyboard may for example be part of a touch screen.

The first instruction may be a function of a number of actuations or of an actuating time.

Such an interface gives lower bulk. For example, the time of pressing on a button determines the commanded variation. Thus, to obtain a high variation in the energy the user presses for a longer time than for to obtain a small variation.

The actuator may form part of an emergency module of the interface. Thus, it is possible to use a first interface with a lever as main interface and a second interface with an actuator as auxiliary interface, for example in case of failure. The two embodiments of the interface are therefore used in a complementary way.

A second aspect of the invention concerns an aircraft comprising a system according to the first aspect.

A third aspect of the invention concerns a method for controlling the energy of a vehicle, for example an aircraft, comprising the following steps:
determining a current state of a control interface, it being possible for said control interface to be in at least one first and one second state, the first state being an instruction state in which the interface generates at least one first instruction for variation of a current energy of the vehicle and the second state being a resting state in which it does not give any instruction, said interface returning to the second state after having been brought into the first state, and if the interface is in the second state,
receiving said at least one instruction, and
controlling at least one device of the vehicle to bring the vehicle to an energy in accordance with said at least one first instruction.

A fourth aspect of the invention concerns a computer program as well as a computer program product and a storage medium for such program and product, enabling the implementation of a method according to the third aspect when the program is loaded into and executed by a processor of a vehicle energy control system.

The objects according to the second and fourth aspects of the invention procure at least the same advantages as those procured by the system according to the first aspect. The objects according to the third and fourth aspects may implement steps corresponding to optional features of the system according to the first aspect.

Other features and advantages of the invention will appear on reading the present detailed description which follows, by way of non-limiting example, and of the appended drawings among which, in addition to FIGS. 1 and 2:

FIG. 3a illustrates an interface of a system according to one embodiment;

FIG. 3b is a graph representing the change over time of the energy of the aircraft according to commands on the interface of FIG. 3a;

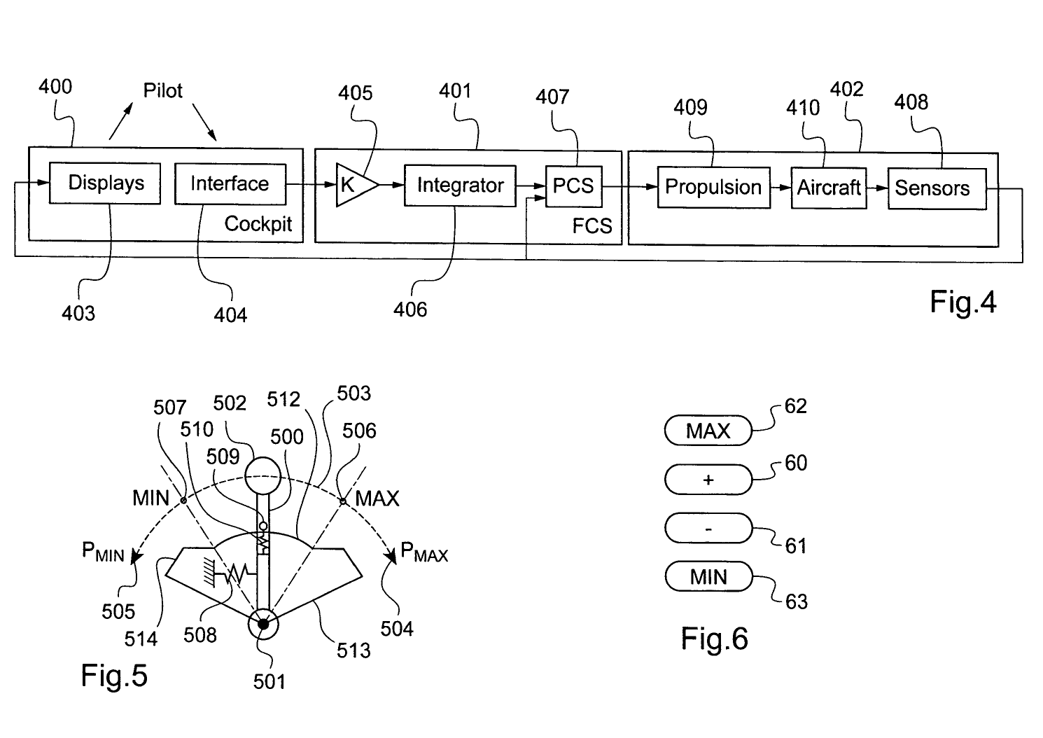

FIG. 4 illustrates a general architecture for a control system according to one embodiment;

FIGS. 5 and 6 illustrate interfaces of systems according to other embodiments;

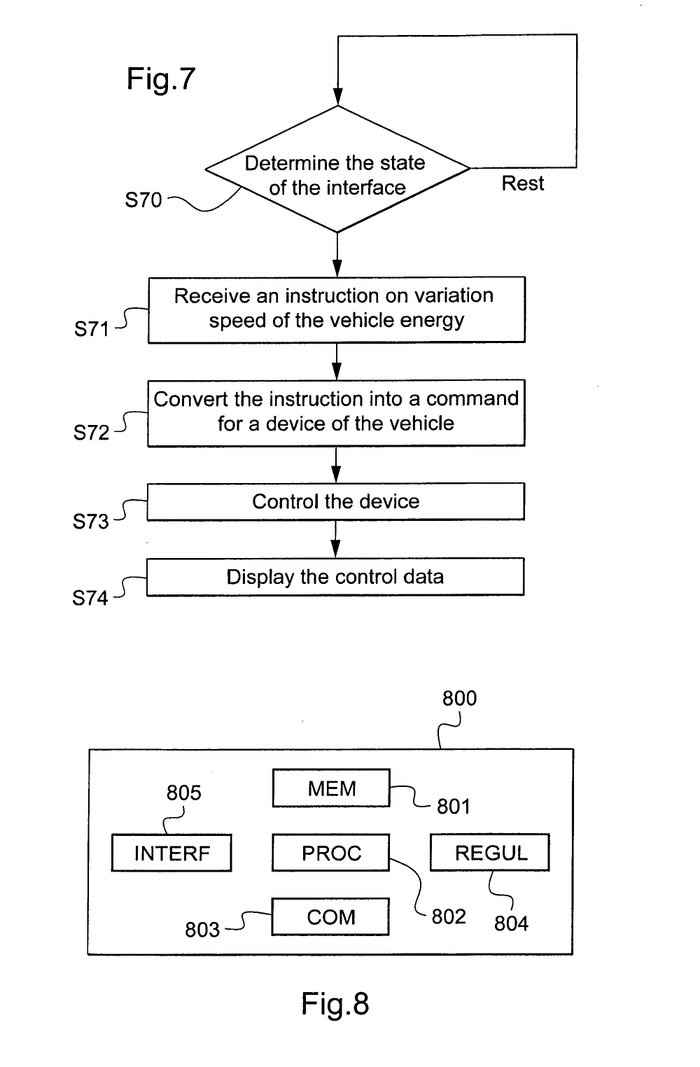

FIG. 7 is a flow chart of steps of a method according to one embodiment; and

FIG. 8 diagrammatically illustrates a system according to one embodiment.

The invention provides a control system making it possible to give instructions for variation of the energy of a vehicle (for example instructions for speed of variation). The instructions are given via an interface which when activated issues an instruction for variation and which once released by the user, always returns to the same resting position corresponding to an absence of instruction.

FIG. 3a represents an interface of a system according to one embodiment. This interface comprises a lever 30 which may pivot around a rotational axis 31 which is orthogonal to the plane of the Figure and of which the free end 32 may travel along a travel path 33 which is located between two terminal positions 34 (MAX) and 35 (MIN) . When it is actuated, the axis 38 of the lever forms an angle 36 (θ) with a vertical axis 37 representing a resting position of the lever. The angle is counted positively clockwise. The lever is returned to its resting position by a return spring 39. This spring may be coupled to a damper (not shown) to avoid oscillations when the lever returns to resting position.

The angle 36 formed between the axes 37 and 38 represents the variation in the energy of the aircraft that the pilot wishes to command. Thus, the greater the angle 36, the more the command increases the energy of the aircraft. If the angle 36 is positive, this variation is an increase and if the angle 36 is negative, this variation is a reduction. In the resting position, the energy of the aircraft does not vary (the command is nil).

By maintaining the lever in a position corresponding to the angle 36, the pilot maintains constant the variation of energy.

FIG. 3b is a graph representing the change over time of the energy of the aircraft according to a first command on the interface of FIG. 3a corresponding to a first value θ1 of the angle 36 and according to a second value θ2 of the angle 36. It is assumed that the value θ1 is less than the value θ2 and that these values are positive.

The x-axis (T) of FIG. 3b represents time, the y-axis (E) represents the energy of the aircraft.

The first curve in solid line represents the change in the energy of the aircraft for a command by the lever with the value θ1 of the angle 36. At a first time t0, the lever is in the resting position. The energy of the aircraft is at a value E1, the aircraft keeps its current energy constant at the value E1 until time t1, at which time the lever is brought into the angular position corresponding to the value θ1 of the angle 36. This value of the angle represents an instruction which is then converted into a command which is received by a regulating unit to act on the devices of the aircraft to modify the variation of its energy. The value of the angle 36 represents a speed of variation of the energy, which results in the present example in a constant slope. At a time t2 the lever is released and returns to its resting position by the action of the spring 39. At time t2, the energy of the aircraft has reached a value E2. As the lever is now in its resting position, no variation in the energy is being commanded, or in other words, the variation commanded is nil. The aircraft thus keeps its energy constant at the value E2.

The second curve in dashed line represents the change in the energy of the aircraft for a command by the lever with the value θ2 of the angle 36. This time, at time t2, the lever is brought into the angular position corresponding to the value θ2 of the angle 36. This value of the angle represents an instruction which is then converted into a command which is received by a regulating unit to act on the devices of the aircraft to modify its energy. The value of the angle 36 results in a constant slope greater than that of the curve in solid line. At the time t2 the lever is released and returns to its resting position by the action of the spring 39. Between the times t1 and t2, for the curve in dashed line the value of the angle 36 is higher than for the curve in solid line. The variation in the energy is then greater which results in a steeper slope. Thus, at time t2, since the value of the angle 36 is greater the energy of the aircraft has reached a value E3 greater than the value E2. As the lever is now in its resting position, as previously, the aircraft keeps its energy constant equal to the value E3.

The curves of FIG. 3b are purely illustrative and do not reveal transient phenomena around the times t1 and t2 reflecting the time the lever takes to reach its command position or return to its resting position. To be precise, between these two positions, the angle 36 takes intermediate values according to the manner of moving the lever.

FIG. 4 represents a general architecture for a control system according to one embodiment of the invention.

This architecture breaks down into three modules 400, 401 and 402.

The first module 400 forms part of the cockpit of the aircraft. It comprises a set of displays 403 to display aircraft control data to the members of the crew in the cockpit. Thus, the crew has information feedback on the state of the aircraft including, among others, the propulsive balance (also called total slope of the aircraft and designating the instantaneous variation in the sum of the kinetic energy and potential energy of the aircraft), from the slope of the aircraft (that is to say the angle between the instantaneous velocity vector of the aircraft and the horizontal plane), from the current thrust level of the engines and from the commanded thrust level of the engines. This information may be displayed in particular on a Head Up Display, on a Navigation Display, on a Primary Flight Display, on a screen dedicated to the state of the engines, or other display.

The module 400 also comprises an interface 404 for a system according to the invention. Thus, a member of the crew, for example the pilot, takes account of the displayed data and takes decisions as to the change in the energy of the aircraft, he then acts on the interface 404 to give orders for reducing or increasing the energy of the aircraft.

The module 400 is connected to a regulating unit 401 of the aircraft. As input the regulating unit receives a control value from the interface 404, for example the angular position of a control lever.

The module 401 is an on-board computer which comprises an amplification unit 405 to convert the value of the instruction, for example the angle value, into an order to vary the energy of the aircraft. This variation order may for example correspond to an order for variation of the thrust of the engines to make the velocity of the aircraft vary (and thus its kinetic energy) or to make the altitude of the aircraft vary (and thus its potential energy). For example, the conversion is made by multiplying by a conversion coefficient. The conversion coefficient (or gain) may be fixed or variable according to flight phases.

In an example of application, the conversion rule may be written

$$\frac{d {P}_{C}}{d t} = K \times θ , {P}_{c}$$

being the thrust commanded and K being a gain or conversion coefficient. In another example, it is an engine parameter such as the parameter N1 of the engines (that is to say a parameter relating to the rotational state).

With this relationship, for a constant angle of the lever, a linear variation of the energy is again encountered as for FIG. 3b.

The gain K may be adjusted according to the point of the flight envelope at which the aircraft is located (the space of the diagram of velocity and altitude within which the aircraft may safely operate), to modify the sensitivity of the interface for better piloting precision.

The output from the amplifier is delivered to an integrator 406 of the module 401. Once the operation of integration has been carried out, the output from the integrator is delivered to a control unit 407 for controlling the thrust delivered by the engines of the aircraft. The control unit 407 corresponds for example to a FADEC computer (FADEC standing for “Full Authority Digital Engine Control”). This unit moreover receives a signal representing the power actually delivered by those engines from a measuring unit 408 in order to ensure the feedback control of the current value of the power delivered by the engines relative to the order Pc.

The control unit delivers a control order to a unit 402 comprising the engine propulsive group 409 of the aircraft comprising the engines. The engine propulsive group then acts on the dynamics of the aircraft represented by a block 410. The measuring unit 408 then takes note of a certain number of items of information, including the current power of the engines, in order to deliver them to the control unit 407 and to display them on the displays 403.

In the preceding example, the control parameter corresponds to the thrust of the engines, however, it may be otherwise and the control parameter may be a high level parameter such as the acceleration or the variation in the total energy of the aircraft (the latter is given by the propulsive balance or the total slope) of the aircraft.

The control by pulse as referred to above makes it possible to vary that high level parameter in the same way as for the thrust of the engines. The system thus provides feedback control of the current propulsive balance or the acceleration based on the target level using all the means available to the aircraft to vary it, in particular: the engines (for the thrust, a positive force which increases the velocity or the rise in kinetic energy), the air brakes or any other controlled device acting on the velocity of the aircraft (to create additional drag, a negative force which slows the aircraft or reduces its kinetic energy).

To complete the possibility of controlling the variation of the aircraft's energy, the command system interface may comprise a specific actuator to directly control one or more specific values of the engine parameter Pc for example such as the thrust. These specific values may be the maximum and minimum values of the available thrust of the engines.

Such an interface is illustrated by FIG. 5.

This interface comprises a lever 500 which may pivot around a rotational axis 501 orthogonal to the plane of the Figure and of which the free end 502 is able to travel along a travel path 503. The travel path 503 extends between a first position 504 (P_{MAX}), commanding a maximum thrust of the engines and a position 505 (P_{MIN}) commanding a minimum thrust of the engines. The travel path 503 also comprises intermediate positions 506 (MAX) and 507 (MIN) respectively commanding maximum and minimum speeds of variation of the energy of the aircraft. In the position represented in FIG. 5, the lever is in a resting position in which it commands nil variation of the aircraft's energy. The lever is returned to this resting position by a return spring 508. This spring may be coupled to a damper (not shown) to avoid oscillations when the lever returns to the resting position.

To mark a difference between the command for a variation in energy and a command for an engine thrust value, the interface is configured to present a mechanical force to the pilot to pass from the position 506 to the position 504 or to pass from the position 507 to the position 505.

To that end, according to one example embodiment, a movable member 509 is arranged to move in guided manner along the axis of the lever 500. The movable member is also held by a return spring 510 to remain in contact with a support 511 when the lever is rotationally driven around the axis 501. The return spring exerts a pulling force on the movable member to return it towards the rotational axis 501.

The support 511 has three parts each being parallel to the travel path 503 of the free end of the lever. A central part 512 has the form of an arc of a circle and extends at a first distance from the axis 501. The movable member moves on this central part when the end of the lever moves between positions 506 and 507. A first terminal part 513 in the form of an arc of a circle extends at a second distance from the axis 501 that is greater than the distance separating the central part 512 from the axis 501. The movable member moves on this first terminal part when the end of the lever reaches position 504. A second terminal part 514 in the form of an arc of a circle extends at the second distance from the axis 501 just like the first terminal part. The movable member moves on this second outermost part when the end of the lever reaches position 505. The support 511 has intermediate parts between the parts 512 and 513 and between the parts 512 and 514.

When the movable member moves from the central part 512 to the first terminal part, the pilot must exert a force to stretch the return spring 510 since the movable member goes away from the rotational axis 501. In the same way, the pilot must exert a force to stretch the spring to pass the movable member from the central part to the second terminal part.

Thus the pilot feels end of travel “notches” at the lever when he has to command a maximum thrust or a minimum thrust of the engines.

Once these notches have been passed beyond, the control system detects the positions 504 and 505 and the system reconfigures the aircraft to carry out a certain number of maneuvers.

For example, when the lever is located in position 504, the system commands the fastest possible increase of the aircraft's energy with a maximum available thrust.

For example again, when the lever is located in the position 505, the system commands a minimum thrust.

The positions 504 and 505 constitute “shortcuts” to easily and intuitively command predefined thrust levels that are useful for certain specific maneuvers of the flight. The intuitiveness comes from the fact that the movement of the handle is identical to the handles of “powered” or “notch” type referred to for the prior art.

In a variant embodiment, the position 504 or 505 of the lever generates an additional command on other control components of the flight of the aircraft such as for example:

the braking system when the aircraft is on the ground,

the airbrake components, and/or

the aerodynamic configuration.

A combination of commands may, for example, be when the lever is in position 504 and the aircraft in flight, to command full thrust as well as a reduction for any deflected airbrake components. By way of illustration, this maneuver is typically used for avoidance in flight, for a go-around maneuver or for a touch and go maneuver.

Another example may be, when the lever is in the position 505 and the aircraft on the ground, to command the strongest possible deceleration of the aircraft by applying a command for minimum thrust (or even the application of reverse thrust using the system of the reversers), an order for maximum deflection of all the airbrakes as well as an order for braking of the wheels.

The combinations of action may depend on the point in the flight or the status of the aircraft.

In some embodiments, as illustrated by FIG. 6, the interface comprises buttons which may be real or presented on a touch screen.

Such an interface comprises a touch 60 (+) to command an increase in the energy of the aircraft and a touch 61 (−) to command a reduction in the energy of the aircraft.

For example, the command for the variation in the energy of the aircraft depends on the number of presses on the buttons 60 or 61. Thus, taking the curves of FIG. 3b as a basis, to obtain a variation in the energy as represented by the curve in solid line, the pilot presses on button 60 N times between times t1 and t2 whereas to obtain a variation as represented by the curve in dashed line, he presses M times, M being greater than N.

For example, each press on a button commands a predefined variation (increase or reduction).

In a complementary manner, the interface may comprise other buttons 62 (MAX) and 63 (MIN) which give command shortcuts having the same functionalities as the positions 504 and 505 of the lever of FIG. 5.

The interface according to the embodiment described with reference to FIG. 6 may for example serve as an emergency interface for an interface with a lever according to FIG. 3a or 5, for example in case of failure.

FIG. 7 is a flow chart of the steps of a method for controlling energy of a vehicle according to one embodiment. This method may for example be implemented by a system according to FIG. 4.

At a step S70, an energy control system determines a state of a control interface. If the interface is at rest, the method again implements the step until it is determined that the interface is in an instruction state. For example, step S70 consists of detecting the imparting of movement to the lever described with reference to FIG. 3b or the pressing on a button of the interface described with reference to FIG. 6. This step may be implemented by a processing unit of the system having the task of controlling it.

Once the instruction state has been detected, the system receives an instruction for varying the energy of a vehicle at a step S71. The system then converts this instruction into a command for a device of the vehicle at a step S7. For example, the conversion is implemented by the association of a gain and of an integrator as described with reference to FIG. 4.

Once the conversion has been carried out, the command is performed at a step S73, for example by the control unit 407.

In a step S74, measurements may be taken to display data relative to the control of the aircraft's energy, for example using the measuring unit 408 and the displays 403.

A computer program for the implementation of a method according to one embodiment of the invention may be produced by the person skilled in the art on reading the flow chart of FIG. 7 and the present detailed description.

FIG. 8 illustrates a control system according to one embodiment. The system 800 comprises a memory unit 801 (MEM). This memory unit comprises a random access memory for temporary storage of the computing data used during the implementation of a method according to an embodiment. The memory unit furthermore comprises a non-volatile memory (for example of EEPROM type) for example for storing a computer program according to an embodiment for its execution by a processor (not represented) of a processing unit 802 (PROC) of the system.

The device furthermore comprises a communication unit 803 (COM1) to perform communication, in particular with devices for controlling the propulsion such as engines, air brakes or other devices. The communication unit may also serve to receive control data coming from a measuring unit as described earlier.

The system also comprises a regulating unit 804 (REGUL) similar to the unit 402 described with reference to FIG. 4 and an interface 805 (INTERF) to issue energy variation instructions as described earlier

Of course, the present invention is not limited to the described embodiments, other variants and combinations of features are possible.

The present invention has been described and illustrated in the present detailed description and in the Figures. The present invention is not limited to the embodiments presented. Other variants and embodiments may be deduced and implemented by the person skilled in the art on reading the present description and appended Figures.

In the claims, the term “comprise” does not exclude other elements or other steps. The indefinite article “a” does not exclude the plural. A single processor or several other units may be used to implement the invention. The different features presented and/or claimed may advantageously be combined. Their presence in the description or in the different dependent claims does not exclude this possibility. The reference signs are not to be understood as limiting the scope of the invention.

1. A system for controlling energy of an aircraft comprising:
a control interface (404, 805) for generating at least one first instruction for speed of variation of a current energy of the aircraft, and
a regulating unit (401, 804) for receiving said at least one first instruction and for controlling at least one device of the aircraft (409) to bring the aircraft to an energy in accordance with said at least one first instruction.
wherein the control interface may be in at least one first and one second state, the first state being an instruction state in which the interface generates said at least one first instruction and the second state being a resting state in which it does not give any instruction and wherein the control interface is configured to return to the second state after having been brought into the first state.

2. A system according to claim 1, wherein the first instruction corresponds to a variation in thrust of at least one engine of the aircraft.

3. A system according to claim 1, wherein the first instruction corresponds to a command for an aerodynamic device of the aircraft.

4. A system according to claim 1, wherein the interface is configured to generate a second control instruction for a thrust value of at least one engine of the vehicle.

5. A system according to claim 1, wherein the interface comprises a lever (30, 500) configured to move angularly around a rotational axis (31, 501) and wherein said at least one first instruction is a function of an angle (36) formed between a current position of the lever and a resting position.

6. A system according to claim 4, wherein the second instruction is generated in an angular position of the lever (504, 505) requiring a force for positioning on a normal travel path of the lever.

7. A system according to claim 1 in combination with claim 1, wherein said second instruction furthermore controls at least one aerodynamic device of the aircraft.

8. A system according to claim 1, wherein the interface comprises at least one actuator (60, 61, 62, 63) for setting off at least one of the first and second instructions.

9. A system according to claim 8, wherein said at least one actuator is configured to set off the first instruction and wherein said first instruction is a function of a number of actuations of said at least one actuator.

10. A system according to claim 8, wherein said at least one actuator is configured to set off the first instruction and wherein said first instruction is a function of an actuating time of said at least one actuator.

11. A system according to claim 8, wherein said at least one actuator forms part of an emergency module of the interface.

12. A system according to claim 8, wherein said at least one actuator forms part of a touch screen.

13. An aircraft comprising a system according to claim 1.

14. A method for controlling the energy of an aircraft comprising the following steps:
determining (S70) a current state of a control interface, it being possible for said control interface to be in at least one first and one second state, the first state being an instruction state in which the interface generates at least one first instruction for speed of variation of a current energy of the aircraft and the second state being a resting state in which it does not give any instruction, said interface returning to the second state after having been brought into the first state, and if the interface is in the second state,
receiving (S71) said at least one instruction, and
controlling (S73) at least one device of the aircraft to bring the aircraft to an energy in accordance with said at least one first instruction.
